(19) United States
(12) Patent Application Publication
(10) Pub. No.: US 2003/0067630 A1
(43) Pub. Date: Apr. 10, 2003

(54) Printer having a thesaurus feature

(76) Inventor: Gary G. Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/973,108

(22) Filed: Oct. 9, 2001

(51) Int. Cl. G06F 17/28; G06F 15/00; G06K 15/02

(52) U.S. Cl. 358/1.16; 715/532; 715/540; 715/531

(57) ABSTRACT

A print apparatus having a thesaurus feature includes a processor and a memory for storing a thesaurus program. The print apparatus may further include a display unit and a control panel so that a user may access the thesaurus program while stationed at the print apparatus. Alternatively, the print apparatus may be coupled to a computer network and may operate like a server computer to allow user access to the thesaurus from any of a number of computers that are also coupled to the network.

The present invention generally relates to a printer having enhanced features, and more particularly to a printer adapted to provide print services and further adapted to provide thesaurus services so that a user may. enhance the vocabulary/terminology appearing in a computer-generated document.

Computer-based word processing software packages are becoming increasingly more sophisticated. For example, many word processing software packages include a variety of features intended to enhance the document creation process, such as a vocabulary-enhancing thesaurus feature that provides a user with a selection of alternative word choices. A thesaurus software feature/package, which may be stored on and executed by the user's computer, typically has one or more databases including, for example, a database having alternative word choices cross-referenced in an appropriate manner. However, these databases are often large and thus, limit the amount of the user's computer memory that is available for other software packages. As a result, word processor software packages that include a thesaurus feature often require more memory than was required for the use of earlier word processor software packages.

In addition, personal digital assistants (PDAs) are becoming more widely used and, with the advent of wireless communication systems like Bluetooth, allow users to access print services offered by a printer. Unfortunately, PDA's typically do not include the amount of memory required to support an enhanced software feature such as a thesaurus software feature. Thus, PDA users, although able to print a document at a printer, are unable to enhance the terminology in the document because they lack access to a thesaurus software package.

Further, when used in the context of a computer network, thesaurus software features/packages and associated databases are often stored on a server computer that is communicatably coupled to a set of user computers that may access and operate the software packages stored on the server. However, when the network server is off-line, i.e., not able to communicate with other network devices, the user can no longer access the features available via the server. Thus, time-critical documents that need to be completed/printed immediately are delayed until the server is repaired and placed back into service. As a result, computer networks are often designed to include additional and/or redundant servers so that network services are not greatly affected when one of the servers goes off-line. However, even these additional servers may become inaccessible to the network computer users during a network crash that causes all network communication to cease.

In addition, network server computers are often used to support a number of network services such that communication traffic between the server and the network computers may become too heavy causing communication on the network to slow down and, in some cases, causing the network to crash and become inoperable.

Moreover, to conserve resources, computer networks typically provide multiple users with access to a limited number of printers. Thus, many of the network users are remotely located from the nearest printer such that the computer users have to travel to the printer to collect their printed documents. However, the document creation process can be especially frustrating to a computer user who, after sending a document to a remotely located printer, remembers that the document is unfinished because he forgot to use the thesaurus software feature/package to enhance the terminology/vocabulary in the document. As a result, the paper on which the unfinished document is printed is wasted and, if the user unnecessarily walked to the remotely located printer before remembering that the document is unfinished, then time is also wasted.

### BRIEF DESCRIPTION OF THE DRAWINGS

FIG. 1 is a block diagram of a print apparatus that is coupled to a user's computer and that provides the user with a thesaurus program according to one aspect of the present invention;

FIG. 2 is a block diagram of a print apparatus that is coupled to a set of users' computers via a communication network and that provides the set of users' computers with a thesaurus program according to another aspect of the present invention;

FIGS. 3A and 3B depict a flow chart representing a method for operating the thesaurus program of the print apparatus of FIGS. 1 and 2 according to a further aspect of the present invention;

FIGS. 4A, 4B and 4C depict a flow chart representing a method for operating the thesaurus program of the print apparatus of FIGS. 1 and 2 according to a further aspect of the present invention; and,

FIG. 5 is a flow chart representing a method for operating the thesaurus program of the print apparatus of FIGS. 1 and 2 according to yet a still further aspect of the present invention.

### SUMMARY OF THE INVENTION

The present invention is directed to a print apparatus having a thesaurus program that enables the enhancement of the terminology in a computer-generated document. The print apparatus includes a processor for executing a thesaurus program and a memory for storing the thesaurus program. A control panel and a display unit associated with the print apparatus enable user interaction with the thesaurus program. The print apparatus may also be coupled to a computer network to provide a plurality of computers that are coupled to the network with access to the thesaurus program.

### DETAILED DESCRIPTION

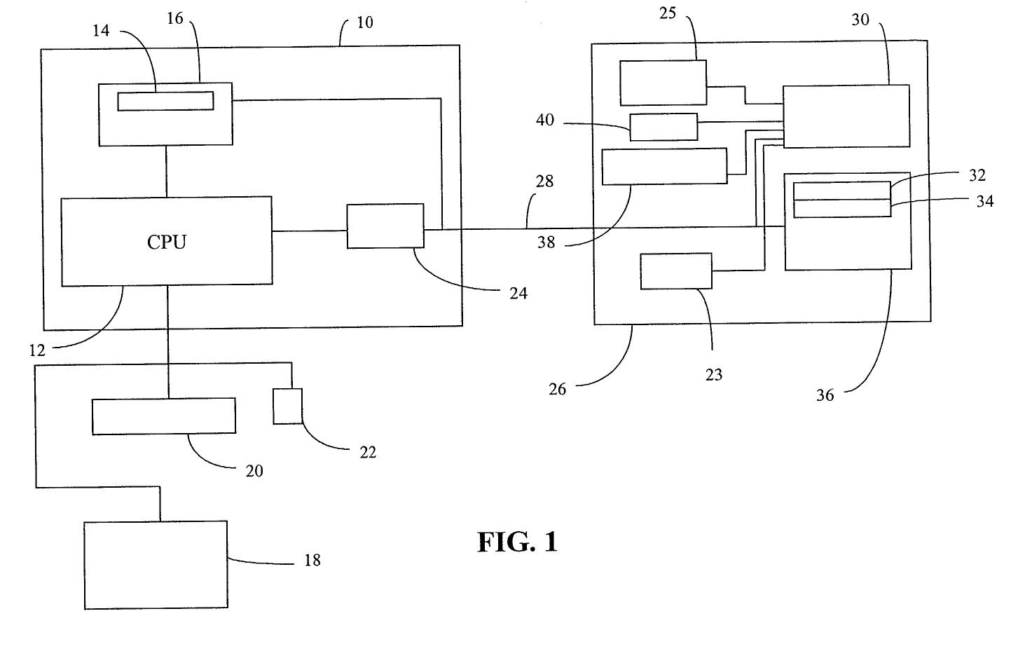

Referring now to the drawings wherein like reference numerals refer to similar or identical parts throughout the several views, and more specifically to FIG. 1 thereof, a computer 10 includes a central processing unit (CPU) 12 that executes an editor program 14 to enable the creation, formatting and editing of computer-generated documents that are stored as document files in a memory 16. A monitor 18, keyboard 20 and mouse 22 enable communication between a user and the CPU 12. Although not shown in FIG. 1, the computer 10 may further include any number of peripheral devices including, for example, a modem, a sound card, a video card, etc. Further, the computer 10 need not be a stationary device but may be implemented with a laptop computer or even with a personal digital assistant (PDA). Moreover, the computer 10 may include a wireless communication device (not shown) that enables wireless communication.

A print driver 24 is also coupled to the CPU 12 for formatting document files stored in the memory 16 for printing at a print apparatus, such as a printer 26, which is coupled to the computer 10 via, for example, a printer cable 28. The printer 26 includes a processor 30 that executes a set of software programs stored in the memory 36, including, for example, a thesaurus program 34 and an editor program 32. In addition, software programs that enable communication between the printer 26 and the computer 10 and that further enable the printing of documents supplied to the printer 26 by the computer 10 may also be stored in the memory 36. In addition to software programs, the memory 36 includes one or more directories designated to store document files received at the printer 26 from the computer 10.

The printer 26 further includes a print module 25 that, under control of the processor 30, enables the printing of documents. The print module 25 may be implemented using any combination of hardware, firmware and software necessary to enable conventional printer functionality. Further, although depicted as separate components, the processor 30 and the print module 25 may be combined to form a single print module.

A reformatter driver 23, which may be implemented via software and/or firmware that is executed by the processor 30, is also coupled to the processor 30 and reformats document files that have been edited at the printer 26. Specifically, conventional print modules are configured to print documents having a specific, print ready format, such as PCL or postscript. As a result, documents are conventionally supplied to a print module in the print ready format. However, editing a document file at the printer 26 may alter the format of the document file causing the print module 25 to be unable to print the document file. Thus, a reformatter driver 23 is provided to reformat document files that have been edited at the printer 26 so that the documents may be printed by the print module 25. As a result, the software or firmware used to implement the reformatter driver 23 is configured to received a document file in a print ready format, locate edited material (improperly formatted material) located in the document file, and convert the edited material to a proper, print ready format. Further, print ready formats such as PCL and postcript are widely available and well known in the art.

A display device 38 such as, for example, a liquid crystal display device, may be disposed on the printer 26 for displaying information generated by the processor 30 and one or more software programs stored in the memory 36 enable control of the display device 38 by the processor 30. In addition, a control panel 40 may be disposed in the printer 26 at a location near the display device 38 so that the user may supply information to the processor 30 while viewing the display device 38. The control panel 40 may include, for example, a set of keys similar to those included on a conventional keyboard or may instead include fewer keys tailored to support the functionality of the printer 26. As will be understood by one having ordinary skill in the art, display devices, control panels and software for operating such devices are widely available. Moreover, such devices are adaptable for usage within a print apparatus in much the same manner that such devices operate within conventional computer systems.

The printer 26, instead of being physically coupled to the computer 10 may be wirelessly coupled to the computer 10. Specifically, the printer 26 may include a wireless communication device (not shown) that enables communication with the wireless communication device (not shown) disposed in the computer 10. In addition, the computer 10 and printer 26 may communicate using a wireless communication protocol such as Bluetooth.

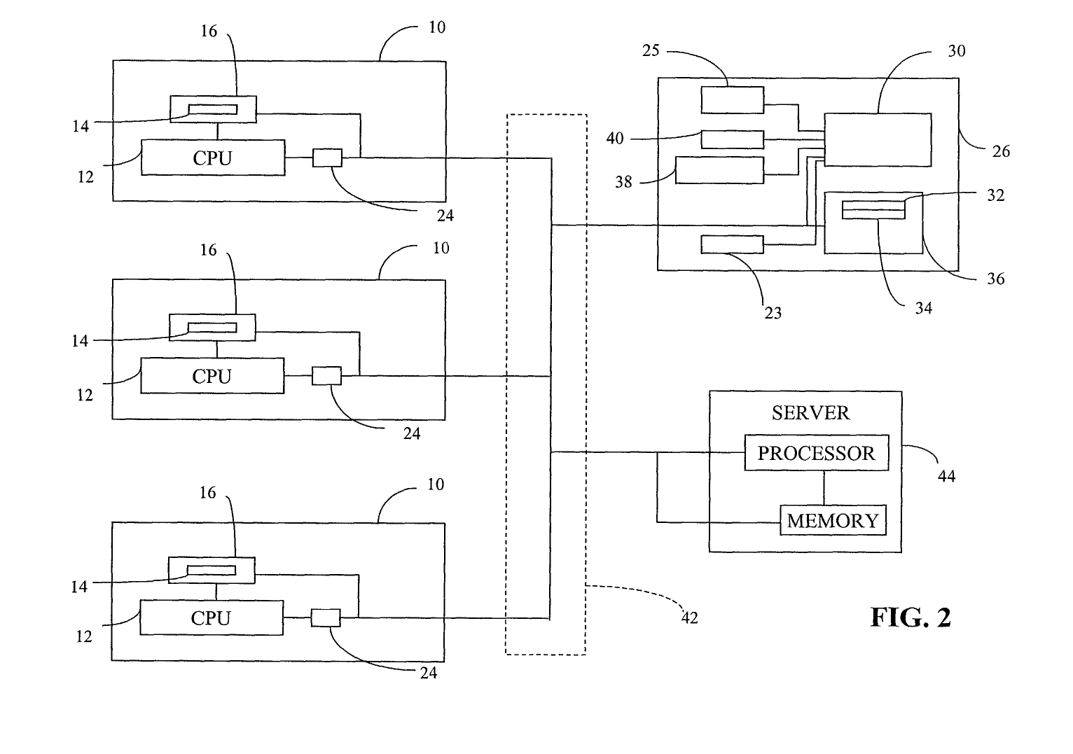

Referring now to FIG. 2, in a second embodiment, the computer 10 may comprise one of a plurality of computers 10 all of which may be coupled to a communication network 42 that is controlled by a network server computer 44. In addition, the printer 26 may be coupled to the communication network 42 and may provide print services to all of the computers 10 coupled to the network 42.

If coupled to the communication network 42, the memory 36 disposed in the printer 26 may include a plurality of directories each associated with one of the computers 10 and each designated to store documents received from the associated computer 10. The processor 30 disposed in the printer 26 may maintain a print queue (not shown) containing the names of the document files stored in the various directories arranged according to the order in which the document files were received from the computers 10. The processor 30 may further print the document files in the order that the names of the document files are arranged in the print queue. If one of the document files listed in the master list is selected by a user for editing, then the processor 30 may temporarily remove the name of the selected document file from the print queue until editing of the selected document file is complete.

As described with respect to FIG. 1, the printer 26 and computers 10 shown in FIG. 2 may be adapted to communicate wirelessly. Specifically, the network 42 may comprise a wireless communication network. For example, the printer 26 and computers 10 may be adapted to include wireless communication devices (not shown) that enable wireless communication via a wireless communication protocol such as Bluetooth. Alternatively, the computers 10 may be adapted to access the printer 26 via a telephone modem.

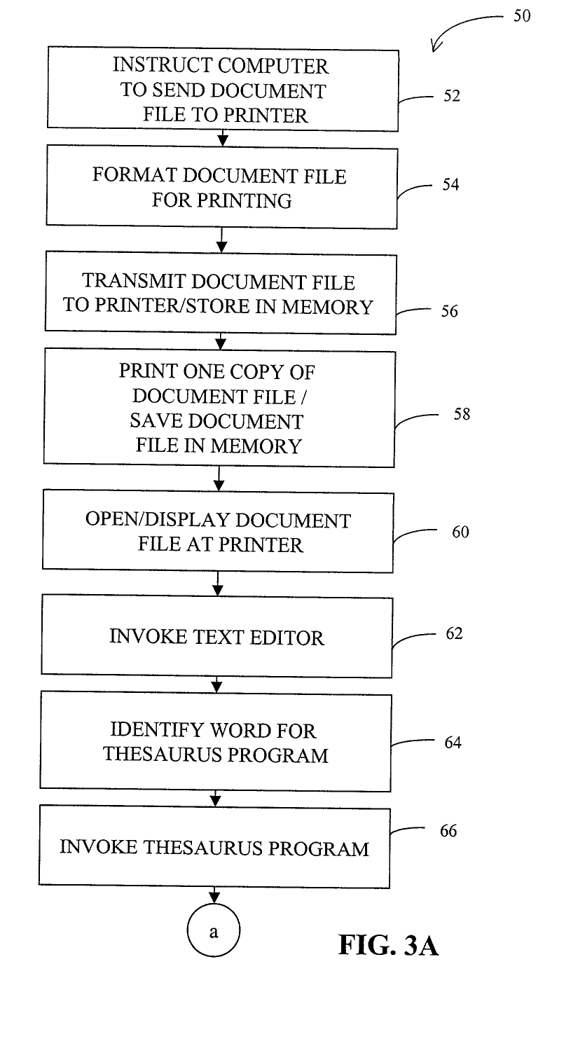

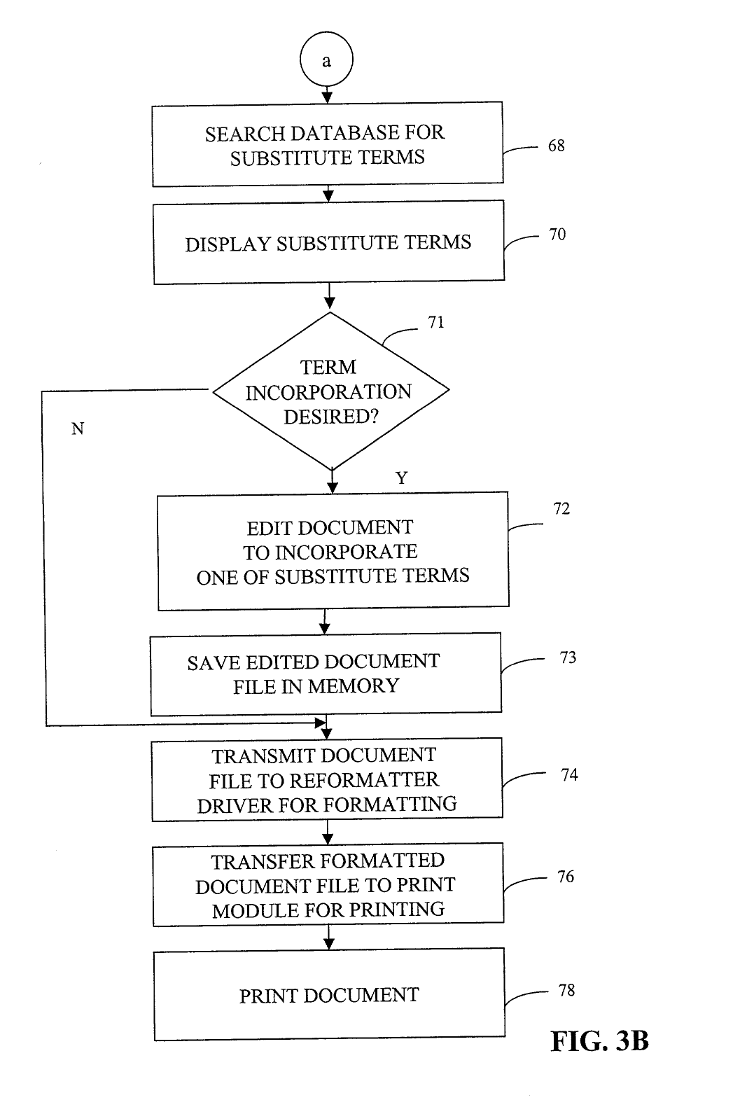

Referring now to FIG. 3 and to FIGS. 1 and 2, the thesaurus program 34 may be invoked and operated via the control panel 40 disposed in the printer 26 using a method 50 that begins when a user instructs the computer 10 to send a document file to the printer 26 (step 52). In response to the instruction, the CPU 12 sends the document file from the memory 16 to the print driver 24 which formats the document file for printing thereby converting the document file into a PCL or a postscript format (step 54). Next, the formatted file is transmitted to the printer 26 where the processor 30 stores the formatted file in the memory 36 (step 56). The processor 30 causes the print module 25 to print a copy of the file while leaving a copy in the memory 36 (step 58). The copy of the document file is retained in the memory 36 so that additional copies may be printed and so that a user may invoke the thesaurus program 34 to enhance the language in the document file, if desired. More particularly, a user stationed at the printer 26 may use the control panel 40 and display 38 to access the memory 36 and locate/open the document file stored in the memory 36 (step 60). Next, the user may invoke the editor program 32 using the control panel 40 so that the language in the document file may be enhanced, if desired (step 62). As will be understood by one having ordinary skill in the art, the document file stored in the memory 36 has either a PCL format or a postscript format, both of which are editable using a basic editor program such as, for example, vi, also known as visual editor, emacs or the DOS “Edit” command. After invoking the editor program, the user identifies one or more words for which the user would like to substitute a synonymous term or for which the user may choose to view antonyms (step 64).

Upon identifying a term, the user selects the term by, for example, causing the term to be highlighted and then invokes the thesaurus program 34 (step 66). The thesaurus program 34 may be selectable using a pull-down menu. Alternatively, the user may enter the term into a data entry field (not shown) that is displayed when the user invokes the thesaurus program 34. Referring also to FIG. 3B which aligns at connection point “a” with FIG. 3A, selecting the thesaurus program 34 causes the processor 30 to search a set of databases associated with the thesaurus program 34 and stored in the memory 36 for a set of words that are synonymous/antonymous with the selected term (step 68). The searching conducted by the processor 30 may be performed using the search techniques employed by conventional thesaurus software programs.

The set of substitute words are then displayed on the display unit 38 (step 70). If desired, the user may choose to edit the document to incorporate one of the substitute words causing the processor 30 to substitute the chosen word for the term originally included within the document (steps 71 and 72). If none of the words is deemed a suitable substitute, the user may instead forego editing the document (step 71). The user may then repeat the steps 64-72 if there are any additional terms for which either synonyms or antonyms are desired.

After using the thesaurus program 34, the user may instruct the processor 30 to save the document file in the memory (step 73) and may then instruct the processor 30 to print the document at which time the processor 30 transmits the document file to the reformatter driver 23 for reformatting (step 74). Reformatting of the document file is performed to ensure that the document file is in a print ready format. Of course, the document was originally supplied to the printer 26 in a print ready format. However, the editing changes made at the printer 26 may have altered the document file in a manner such that reformatting is required to enable printing of the document file by the print module 25. Thus, the document file, which was originally supplied to the printer in a print ready format but has been edited, is supplied to the reformatter driver 23 which converts the document to a print ready format. Finally, the processor 30 causes the reformatter driver 23 to transmit the reformatted document file to the print module 25 (step 76) where the document file is printed (step 78).

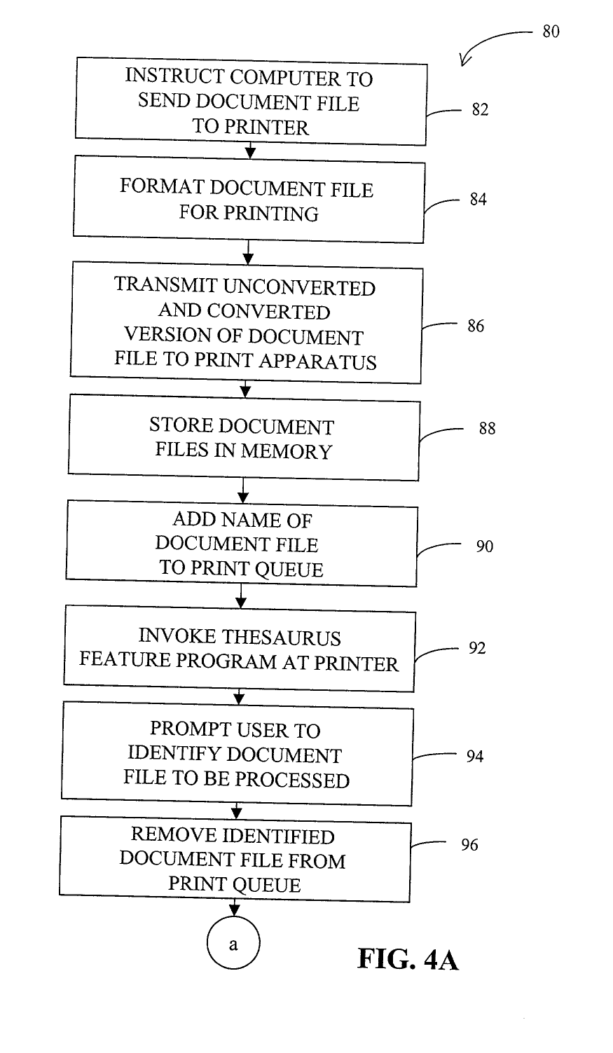

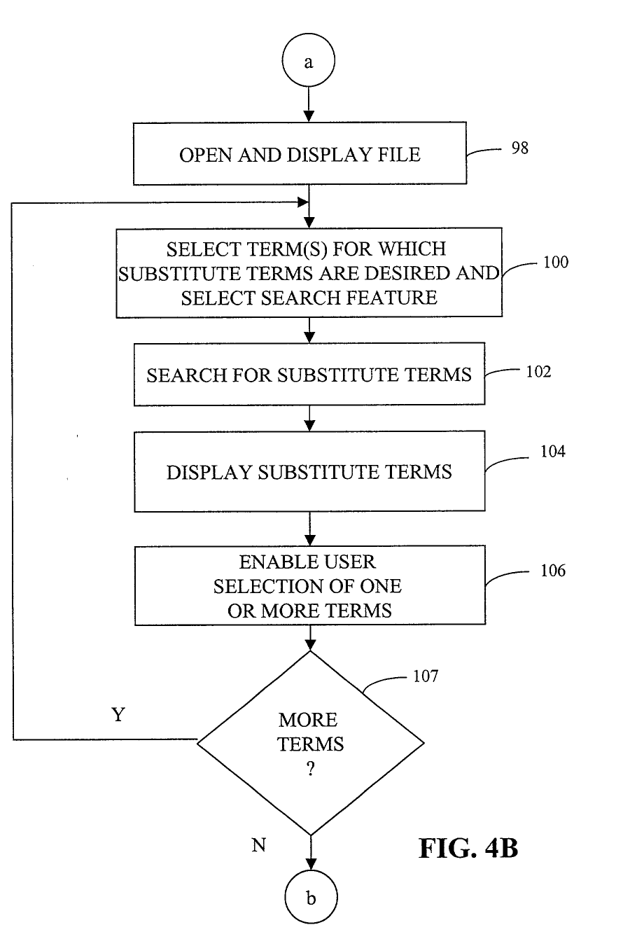

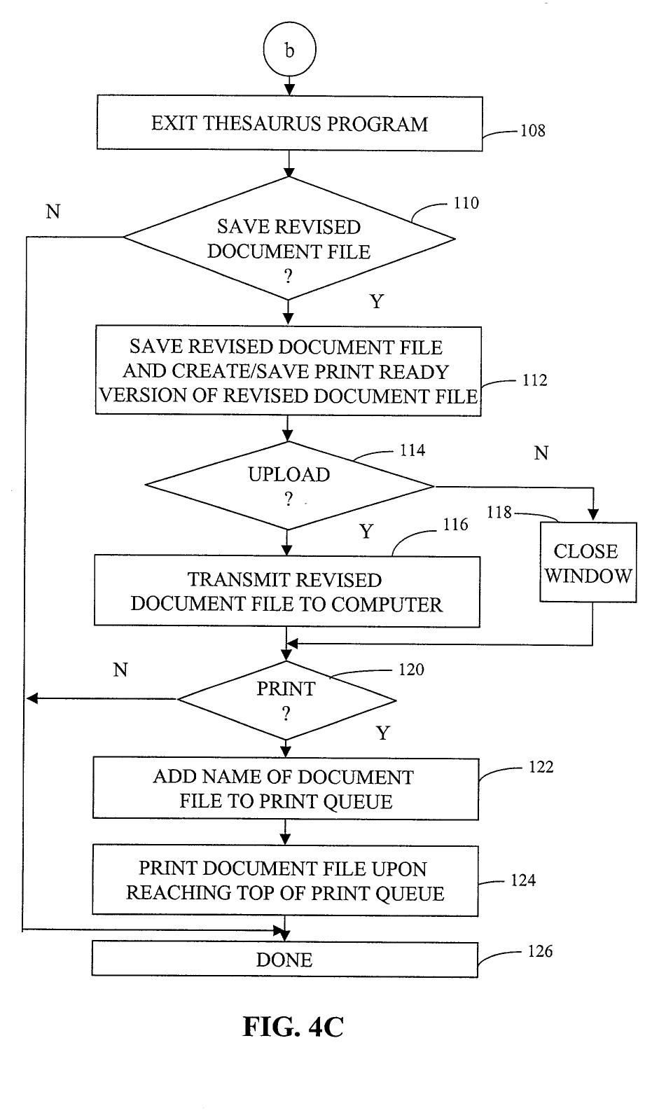

Referring now to FIG. 4A and to FIGS. 1 and 2, in an alternative embodiment, the printer 26 may have greater editing capabilities such that the original, non print-ready version of the document may be edited at the printer 26. For example, a method 80 for operating the thesaurus program 34 may begin when a user instructs the computer 10 to send a document file from the memory device 16 disposed in the computer 10 to the printer 26 for printing (step 82). The document file may include any type of computer-generated file that contains any printable matter. The CPU 12 responds to the instruction by invoking the print driver 24 which creates and stores a print ready version of the document file that is formatted according to a print format or protocol that is compatible with a format used by the processor 30 and/or the print module 25 residing in the printer 26 (step 84). Preferably, the print driver 24 does not alter the original version of the document file so that, after the print ready version of the document file has been created/stored at the computer 10, two versions of the document file reside in the memory 16, i.e., an original, unconverted version and a print ready version.

Next, the print driver 24 transmits the print ready version of the document file to the printer 26 for printing and further transmits the original version of the document file to the printer 26 for editing, if desired (step 86). Note that, unlike the original version of the document file, the print ready version has been converted to a new format and may no longer be readable/recognizable to the editor program 32 disposed in the printer 26. Thus, the unconverted, original version of the document file is sent to the printer 26 along with the print ready version so that, if desired, the document file may be edited at the printer 26 before being printed. Of course, if the format of the print ready version is recognizable to the editor program 32 and thus editable at the printer 26, then only the print ready version need be transmitted to the printer 26. Alternatively, the original version of the document file may be transmitted to the printer 26 and, if desired, edited at the printer 26. After the original version has been edited, the processor 30 disposed in the printer 26 causes the reformatter driver 23 to convert the document file to a print ready format for printing. In this embodiment, the reformatter driver 23 may be implemented with a conventional print driver 24.

As described, upon receipt of the two versions of the document file at the printer 26, the processor 30 disposed in the printer 26 causes the original and print ready versions of the document file to be stored in the memory 36 (step 88). If the thesaurus program 34 is installed in the printer 26 coupled to the network 42 (see FIG. 2), then the processor 30 causes the document files received from the computer 10 to be stored in a directory associated with the computer 10 from which the document files were received. Although the processor 30 may use any desired naming/storing scheme for naming/storing the document files received from the computer 10, the naming scheme preferably includes storing the documents under names that are recognizable to the user so that, if editing at the printer 26 is desired, the user can identify the document file to be edited.

In addition to storing the two versions of the document files, the processor 30 disposed in the printer 26 also causes the name of the print ready version of the document file to be added to a print queue that contains the names of all pending print jobs and that is used to control the order in which document files stored in the printer memory 36 are printed (step 90). The processor 30 maintains the print queue in a manner such that, as each document file is printed, the name of the printed document file is removed from the print queue and the next consecutive document file listed by name in the print queue becomes the next document file to be printed. If the thesaurus program 34 is installed in the printer 26 coupled to the network 42 (see FIG. 2), then the name of the document file added to the print queue may further include the pathname/directory in which the document file is stored so that the processor 30 can locate the document file for printing.

Next, while stationed at the printer 26, the user invokes the thesaurus program 34 using the control panel 40 (step 92). The user may invoke the thesaurus program 34 using any conventional method. For example, the user may press an appropriate one of the keys disposed on the control panel 40 thereby selecting an icon displayed on the display unit 38 and associated with the thesaurus program 34. Alternatively, the processor 30 may operate as a menu driven system wherein a set of programs/features are selectable via one or more pull-down menus.

After the thesaurus program 34 has been invoked, the processor 30 prompts the user to identify the document file to be processed by the thesaurus application 34 (step 94). If the thesaurus program 34 is installed in the printer 26 that is coupled to a plurality of computers 10 via a network 42 (see FIG. 2), then the processor 30 may prompt the user to enter the name of the document file to be edited and the name of the directory in which the document file is stored. Of course, in order to do so, the user must be pre-informed as to the name of the directory in which the user's document files are stored.

Provided that the identified document file has not yet been printed, the processor 30 removes the name of the identified document file from the print queue to ensure that any editing performed while using the thesaurus program 34 is incorporated into the printed version of the document (step 96). Referring also to FIG. 4B which aligns with FIG. 4A at connection point “a,” in addition to removing the name of the print ready version of the document file from the print queue, the processor 30 opens and, depending on the size of the display unit 38, displays all or a portion of the original version of the document file on the display unit 38 (step 98). Of course, if only a portion of the document file is viewable at a single time, then the control panel 40 will include keys that allow the user to scroll through the text of the document causing the remaining portions of the document file to be viewable.

To ensure that the document file is not printed before the user has had adequate time to edit the document file using the thesaurus program 34, the print driver 24 disposed in the computer 10 may allow the user to indicate, upon transmitting the original and print ready versions of the document file to the printer 26, whether the print ready version of the document file shall be printed immediately or whether printing of the document file shall be delayed by an amount of time sufficient to allow the user to edit the document file using the thesaurus program 34 at the printer 26. Alternatively, the processor 30 disposed in the printer 26 may automatically delay the printing of all document files received at the printer 26 for a period of time sufficient to allow the user to invoke the thesaurus program 34, should such usage be desired. Additionally, if the document file is not edited at the printer 26 within the printing delay time period, then the processor 30 may delete the unconverted version of the document file from the printer memory 36 automatically at the end of the printing delay time period.

In yet another embodiment, the print driver 24 may allow the user to specify that the document file shall be sent to the printer 26 for storage but not printed. Thus, the user will have an unlimited amount of time to edit the document at the printer before printing. To ensure that the memory 36 in the printer 26 does not become overloaded, the processor 30 disposed in the printer may cause files to be deleted after a desired time period such as, for example, twenty four hours. Alternatively, the printer 26, upon receiving the document file may cause the document file to be printed but retain an editable copy of the document file in the memory 36 in case additional changes are desired.

Next, assuming that the document file has been successfully opened for editing, the user may identify one or more words in the document file for which the user would like to substitute a synonymous term or for which the user may choose to view antonyms. After identifying a term, the user selects the term by, for example, causing the term to be highlighted and then selects a search feature associated with the thesaurus program 34. The search feature may be selectable using a pull-down menu provided by the thesaurus program 34. Alternatively, the user may enter the term into a data entry field (not shown) that is displayed when the user invokes the thesaurus program 34. In either event, selecting the search feature causes the processor 30 to search a set of databases associated with the thesaurus program 34 and stored in the memory 36 for a set of words that are synonymous/antonymous with the selected term (step 102). The searching conducted by the processor 30 may be performed using the search techniques employed by conventional thesaurus software programs.

The set of substitute words are then displayed on the display unit 38 (step 104). If desired, the user may choose one of the substitute words causing the processor 30 to substitute the chosen word for the term originally included within the document (step 106). If none of the words is deemed a suitable substitute, the user may instead choose to close a window in which the set of substitute words is displayed (step 106). Referring also to FIG. 4C which aligns with FIG. 4B at connection point “b,” the user may then repeat the steps 100-106 if there are any additional terms for which either synonyms or antonyms are desired (step 107) or, if there are not any additional terms that require substitution, then the user may exit the thesaurus program 34 (step 108).

Upon exiting the thesaurus program 34, the processor 30 may generate a prompt asking whether the user wishes to save the revised version of the document file (step 110). If the user elects to save the revised version of the document file, the processor 30 causes the revised version of the document file to be stored in the memory 36 and then causes the reformatter driver 23 to create and store a print ready version of the revised document file for printing (step 112). Of course, if the thesaurus program 34 is installed in a printer 26 that is coupled to a network 42 of computers 10, the processor 30 stores the document file in the directory associated with the user's computer and deletes or overwrites the earlier, unrevised version of the document file. If the user does not choose to save the revised version of the document, then the processor 30 is done processing the document file (step 146).

If instead the revised print ready version of the document file has been saved, the processor 30 transmits a prompt to the CPU 12 for display at the computer 10 (step 114). The prompt may remind the user that the revised document file has been saved in the memory 36 and indicate that the user may upload the revised version of the document file from the printer 26, if desired.

Upon viewing the prompt that indicates that the revised version of the document file has been stored in the memory 36, the user may elect to upload the revised version of the document file from the printer 26 to the memory 16 disposed in the computer 10 (step 116), or, if the user does not wish to upload the document file, the user may instead close the window containing the prompt without uploading the document file (118).

Next, the processor 30 generates a prompt asking the user whether printing of the revised document is desired and further asking the user to indicate whether the entire document file or only a subset of the document file shall be printed (step 120). The prompt may further include a first button that the user selects to indicate that printing of the document file is not desired, a second button that the user selects to indicate that printing of the entire document file is desired and a third button that the user selects to indicate that only a subset of the document file is to be printed. If the first button is selected, then the document file is not printed and the processor 30 is done processing the documenting file (step 126). If either the second button or third button is selected, then the processor 30 adds the name of the revised, print ready version of the document file to the print queue for printing (step 122). If the third button is selected, the processor 30 also receives and stores user-entered data indicating the pages of the document file to printed (step 122). When the name of the document file reaches the head of the print queue, the processor 30 causes the document file to be printed by the print module 25 (step 124) either in whole or in part depending on what the user specified at the step 92.

As will be appreciated by one of ordinary skill in the art, in order to enable display and editing of the document file using the thesaurus program 34 in the manner described above, the thesaurus program 34 may be capable of displaying and editing the document file in response to input entered by the user. Thus, the thesaurus program 34 may include at least a minimal level of text display and text editing capabilities. Alternatively, the thesaurus program 34 may execute in conjunction with the text/graphics editing program 32 (see FIGS. 1 and 2) in a manner that is transparent to the user. In another embodiment, the thesaurus program 34 may not be associated with any editing capabilities in which case the user may simply use the thesaurus program 34 to display possible term substitutes that the user may then enter into the document via the editor program 32 that operates independently of the thesaurus program 34.

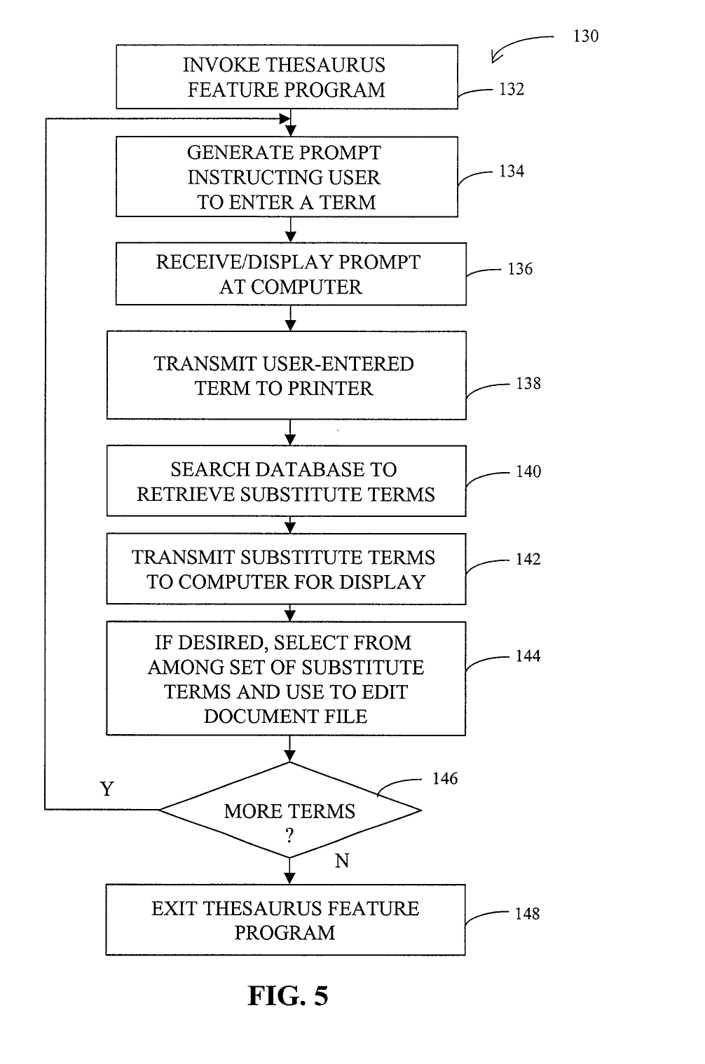

Referring now to FIG. 5 and to FIGS. 1 and 2, the thesaurus program 34 may also be operated by a user stationed at the computer 10. Specifically, a second method 130 for operating the thesaurus program 34 may begin when the user invokes the thesaurus program 34 by, for example, using the mouse 22 to click on an icon associated with the thesaurus program 34 (step 132). The icon may be displayed on the monitor 18 in much the same manner as icons associated with software programs stored in the computer memory 10 are displayed such that the user is not even aware that the thesaurus program 34 is stored elsewhere, i.e., in the printer memory 36. As will be understood by one of ordinary skill in the art, the icon will have to be loaded into the computer 10 and associated with invoking the thesaurus program 34. For example, clicking on the thesaurus program icon may cause the software associated with the icon to provide a signal to the print driver 24 which may send a signal that causes the printer processor 30 to begin executing the thesaurus program 34.

After being invoked, the thesaurus program 34 may prompt the user to enter a term for which a substitute word is desired (step 134). Specifically, the thesaurus program 34 may cause the processor 30 disposed in the printer 26 to generate the prompt (step 134) and may then cause the processor 30 to transmit the prompt to the print driver 24 disposed in the computer 10. Upon receiving the prompt, the print driver 24 forwards the prompt to the CPU 12 which displays the prompt on the monitor 18 (step 136). The prompt may include any message sufficient to cause the user to enter a term and may include, for example, a data entry field into which the user may type the term. The prompt may further include a user-selectable enter button that, when clicked, causes the CPU 12 to transmit the entered term to the print driver 24 which may then forward the term to the processor 30 disposed in the printer 26 (step 138).

The processor 30, operating according to the thesaurus program 34, searches a database for an associated set of synonymous/antonymous words and retrieves the associated set of substitute words therefrom (step 140). As described above, the thesaurus program 34 may retrieve the set of substitute words using conventional thesaurus software program search techniques. The thesaurus program 34 then causes the processor 30 disposed in the printer 26 to transmit the retrieved set of substitute words to the print driver 24 which forwards the set of substitute words to the CPU 12 for display on the monitor 18 (step 142). The user may then select a desired one of the words to serve as a substitute for the term originally included in the document file and may enter the desired substitute word into the document in place of the original term (step 144). Preferably, although not necessarily, the document file is stored in the memory 16 disposed in the computer 10 so that the document file may be edited in the same manner used to edit any other document file stored in the memory 16.

Alternatively, the user may decide that none of the set of words is an appropriate substitute for the selected term in which case the user does not enter any of the set of words into the document. After the user has finished selecting from the set of words, the user may choose to use the thesaurus program 34 to obtain substitute words for one or more other terms included in the document file (repeat steps 134-144). Alternatively, the user may opt to exit the thesaurus program 34 (step 146) by, for example selecting an exit button associated with the display of terms. After editing the document, the user may elect to have the document file printed, in which case the document file is converted to a print ready format by the print driver 24 and then transmitted to the printer 26 for printing.

According to another embodiment, during the second method 130 the document file may instead be stored in the printer memory 36 because, for example, the user may have transmitted the document file to the printer 26 for printing before invoking the thesaurus program feature 34. Provided that the document file has not yet been printed, the thesaurus program 34 may cause the processor 30 to transmit the document file to the computer 10 for editing and may temporarily remove the name of the document file from the print queue.

When editing is complete, the CPU 12 transmits the edited document file to the print driver 24 to create a print ready version of the document file. The print ready version is then transmitted to the processor 30 disposed in the printer 26 and stored in the printer memory 36. Finally, the processor 30 adds the name of the print ready version of the document file to the print queue for printing.

Referring still to FIG. 5, the printer 26, computer 10 and thesaurus program 34 may be adapted such that, when operated at the computer 10, the thesaurus program 34 behaves as though it were installed in the memory 16 disposed in the computer 10 in the same way that conventional network computers operate remotely located software provided by conventional network servers. In addition, the thesaurus program 34 may operate in a manner that causes the thesaurus program 34 to appear fully integrated with the editor program 14 installed in the computer 10 or with the editor program 32 installed in the printer 26. For example, the editor programs 14, 34 may each include a pull-down menu having a thesaurus menu item that, when selected, invokes the thesaurus program 34. Further, the thesaurus program 34 may interact with either of the editor programs 14, 34 in a manner that is transparent to the user such that the user is not even aware that the thesaurus is supplied via a separate software program.

From the foregoing description, it should be understood that a print apparatus adapted to provide thesaurus services has been shown and described, having many desirable attributes and advantages. In particular, the print apparatus allows a user to obtain thesaurus services while stationed at the print apparatus. In addition, providing a print apparatus adapted to supply thesaurus services eliminates the need to install a thesaurus software program on the user's computer thereby conserving the space available on the user's hard drive. Further, the print apparatus adapted to supply thesaurus services provides a user with an additional safety net in the event that the computer network crashes. Specifically, the print apparatus adapted to supply thesaurus services may be used to identify substitute terms in a document that has been sent to the print apparatus prior to the network crash. Thus, if after sending the document to the print apparatus the user wishes to enhance the document by substituting one or more of the terms in the document with synonyms/antonyms, then the user may use the print apparatus to identify substitute terms for the document even though the network is inoperable.

While various embodiments of the present invention have been shown and described, it should be understood that other modifications, substitutions and alternatives are apparent to one of ordinary skill in the art. For example, as described herein, the print apparatus adapted to provide thesaurus services may include a display unit and a control panel so that the user may obtain thesaurus services directly from the print apparatus. In addition, the print apparatus may also provide the thesaurus service to the user via the user's computer.

Further, the computer 10 need not be a stationary device but may instead be a mobile device such as a laptop computer or a personal digital assistant (PDA). In addition, the computer 10 need not have editing capabilities. Thus, for example, a person using a PDA having the ability to download, display, and store, for example, e-mail messages may access the thesaurus provided via the print apparatus 26. Specifically, the PDA user may print an e-mail message at the print apparatus 26 and then use the thesaurus while stationed at the print apparatus 26 to enhance the vocabulary in the email message. Moreover, the computer 10 or PDA need not communicate with the print apparatus 26 via a hardwired connection but may instead be adapted to communicate with the print apparatus wirelessly. For example, the print apparatus 26 and the PDA may be adapted to include a wireless communication device that enable communication via a wireless communication protocol such as Bluetooth.

Further, the thesaurus program is described herein as being invoked in response to the selection of a user-selectable icon or user-selectable display menu. Alternatively, the thesaurus program may be executable in any known manner. For example, the print apparatus may have a button located on the control panel that, when pressed, invokes the thesaurus program. Alternatively, the print apparatus may operate in any of a variety of modes, one of which may be associated with the execution of the thesaurus program such that placing the print apparatus into the proper mode causes the processor disposed in the print apparatus to execute the thesaurus program.

In addition, the thesaurus program is described herein as generating a set of display windows that enable user-interaction with the program so that, for example, a term may be selected for processing. Alternatively, the thesaurus program may generate text messages and accept input in any of a variety of ways. For example, the thesaurus program may generate messages/prompts that scroll across the display unit or across the computer monitor. Further, instead of providing a window having a text field into which a term may be typed, the thesaurus program may accept a user-highlighted term as input.

Moreover, as described above, the print apparatus may provide word processing or editing services that operate seamlessly with the thesaurus service or may instead supply editing services that operate separately from the thesaurus service.

What is claimed is:

1. A print apparatus adapted to provide a thesaurus feature, said print apparatus comprising:
a print module for printing a document file;
a processor coupled to said print module, said processor controlling said print module;
a memory device coupled to said processor, said memory device storing a thesaurus program; and
wherein said processor executes said thesaurus program stored in said memory device.

2. The print apparatus of claim 1 further comprising:
a control panel coupled to said processor, said control panel enabling user control of said processor; and,
a display unit coupled to said processor, said display unit displaying a set of display information generated by said processor during execution of said thesaurus program, and said display unit further displaying said document file.

3. The print apparatus of claim 1 wherein said document file is stored in said memory device.

4. The print apparatus of claim 1 further comprising an editor program stored in said memory device, said editor program enabling said user to edit said document file.

5. The print apparatus of claim 4 wherein said editor program is integrated with said thesaurus program such that, while said editor program is being executed, a set of features associated with said thesaurus program are selectable by said user without having to separately invoke said thesaurus program.

6. The print apparatus of claim 1 wherein said processor comprises a first processor and wherein said first processor executes said thesaurus program in response to a signal generated by a second processor that is communicatably coupled to said print apparatus.

7. The print apparatus of claim 6 wherein said first processor further causes a set of display information generated while executing said thesaurus program to be supplied to said second processor for display by a display unit coupled to said second processor.

8. The print apparatus of claim 7 wherein said memory device comprises a first memory device and wherein said document file is stored in a second memory device coupled to said second processor.

9. The print apparatus of claim 7 wherein said first processor, while executing said thesaurus program, responds to data received from said second processor.

10. The print apparatus of claim 1 further comprising a reformatter driver for formatting said document for printing by said print module.

11. A method for a processor disposed in a print apparatus, said method comprising the steps of:
a) executing a thesaurus program for enhancing terminology in a document file;
b) enabling editing of said document file to incorporate one or more of a set of terms identified via execution of said thesaurus program;
c) saving said document file having said one or more of said set of terms incorporated therein as a revised document file in a memory device; and,
d) causing a print module to print said revised document file.

12. The method of claim 11 further comprising the steps of:
removing a name of said document file from a print queue containing a plurality of names of document files to be printed before executing said thesaurus program; and,
adding a name of said revised document file to said print queue before causing said print module to print said document file.

13. The method of claim 11 wherein said processor comprises a first processor and wherein said memory device comprises a first memory device, said method further comprising the step of:
causing a prompt to be displayed on a display unit, said prompt instructing a user to copy said revised version of said document file from said first memory device to a second memory device associated with a second processor.

14. The method of claim 11 wherein said processor comprises a first processor, and wherein step a) through step d) are performed by said first processor in response to signals received from a second processor that is communicatably coupled to said first processor.

15. The method of claim 11 further comprising the step of:
converting said revised version of said document file to a print ready format before causing said print module to print said revised version of said document file.

16. The method of claim 11 wherein said processor comprises a first processor, and wherein said method further comprises the step of
informing a second processor that said revised version of said document file is available for uploading.

17. A computer program product comprising a computer readable code stored on a computer readable medium, that when executed, causes a computer to:
a) execute a thesaurus program for enhancing terminology in a document file;
b) enable editing of said document file to incorporate one or more of a set of terms identified via execution of said thesaurus program;
c) save said document file having said one or more of said set of terms incorporated therein as a revised document file in a memory device; and,
d) cause a print module to print said revised document file.

18. The computer program product of claim 17 wherein said computer readable code further causes said computer to:
remove a name of said document file from a print queue containing a plurality of names of document files to be printed before executing said thesaurus program; and,
add a name of said revised document file to said print queue before causing said print module to print said document file.

19. The computer program product of claim 17 wherein said memory device comprises a first memory device and wherein said computer comprises a first computer and further wherein said computer readable code further causes said first computer to cause a prompt to be displayed on a display unit, said prompt instructing a user to copy said revised version of said document file from said first memory device to a second memory device associated with a second computer.

20. The computer program product of claim 17 wherein said computer comprises a first computer and wherein said computer readable code further causes said first computer to perform steps a) through d) in response to signals received from a second computer that is communicatably coupled to said first computer.

21. The computer program product of claim 17 wherein said computer readable code further causes said computer to convert said revised version of said document file to a print ready format before causing said print module to print said revised version of said document file.

22. The computer program product of claim 17 wherein said computer comprises a first computer and wherein said computer readable code further causes said first computer to inform a second computer that said revised version of said document file is available for uploading.
